(19) United States
(12) Patent Application Publication
(10) Pub. No.: US 2008/0295696 A1
(43) Pub. Date: Dec. 4, 2008

(54) WASHING MACHINE HAVING DEHUMIDIFYING APPARATUS AND DEHUMIDIFYING METHOD THEREOF

(76) Inventor: Young-Jong KIM, Changwon (KR)

Correspondence Address: BIRCH STEWART KOLASCH & BIRCH, PO BOX 747, FALLS CHURCH, VA, 22040-0747, US

(21) Appl. No.: 12/127,681

(22) Filed: May 27, 2008

(30) Foreign Application Priority Data
May 28, 2007 (KR) 10-2007-0051685

(51) Int. Cl. D06F 35/00; B01D 50/00

(52) U.S. Cl. 96/417; 68/13 R

(57) ABSTRACT

Disclosed is a washing machine having a dehumidifying apparatus and a dehumidifying method thereof, the washing machine comprising: a casing forming an appearance, a door installed at one side of the casing so as to receive laundry therein, a top cover opened/closed by the door, an outer tub installed in the casing, an inner tub rotatably installed in the outer tub, and a dehumidifying apparatus for removing moisture generated from the laundry, accordingly it is capable of less generating a foreign substance or odor caused by moisture left in the washing machine after the washing completion and of increasing a dehumidifying efficiency by periodically or repeatedly dehumidifying the washing machine using the dehumidifying apparatus.

### BACKGROUND OF THE INVENTION

1. Field of the Invention

The present invention relates to a washing machine having a dehumidifying apparatus, and more particularly, to a washing machine having a dehumidifying apparatus which is capable of removing moisture generated from laundry when a user does not take out the laundry that has already washed, and a dehumidifying method thereof.

2. Description of the Related Art

Generally, a washing machine serves to remove pollutes from laundry such as clothes, bedclothes by applying emulsification of detergent, friction of flowing water resulting from rotation of a pulsator, a mechanical impact to the laundry by the pulsator, etc.

The washing machine includes a casing forming an appearance, an outer tub received in the casing, an inner tub received in the outer tub and rotated at the time of a wash or dehydration process, a motor installed below the outer tub and rotating the pulsator and the inner tub, and a clutch determining a transfer direction of a driving force of the motor thus to rotate both the pulsator and the inner tub in the wash process and rotate only the inner tub in the dehydration process.

Meanwhile, washing machines can be classified into two types, according to an installation direction of a rotation shaft of a drum or the inner tub processing laundry such as clothes. That is, a washing machine having a rotation shaft that is vertically disposed is referred to as a top loading washing machine, and a washing machine having a rotation shaft that is horizontally disposed is referred to as a front loading washing machine or drum washer.

In use of the related art washing machine, when a user does not take out the laundry after a washing completion or an apparatus controlling an operation course is out of order thus cannot proceed to the next course, the laundry containing moisture is left in the hermetic washing machine.

As such, when the laundry is left long time after washing completion (i.e., the laundry is washed), the laundry or an inside of the washing machine may be polluted with mold, etc. or smelly due to the moisture contained in the laundry.

However, in the washing machine according to the related art, there is not a separate dehumidifying apparatus for removing the pollutes such as mold or the odor.

### SUMMARY OF THE INVENTION

Therefore, the present invention is firstly directed to providing a washing machine having a dehumidifying apparatus which is capable of removing moisture generated from laundry left in the washing machine after washing completion (i.e., the laundry is washed).

A second object of the present invention is to provide a washing machine having a dehumidifying apparatus which is capable of less generating a foreign substance or odor caused by moisture in the washing machine after washing completion.

A third object of the present invention is to provide a dehumidifying method of a washing machine which is capable of periodically dehumidifying using a dehumidifying apparatus thus to increase a dehumidifying efficiency.

A fourth object of the present invention is to provide a dehumidifying method of a washing machine which is capable of automatically dehumidifying when an opening of the washing machine is not sensed for a certain time thus to provide a user with convenience.

To achieve these and other advantages and in accordance with the purpose of the present invention, as embodied and broadly described herein, there is provided a washing machine comprising: a casing forming an appearance; a door installed at one side of the casing so as to receive laundry therein; a top cover opened/closed by the door; an outer tub installed in the casing; an inner tub rotatably installed in the outer tub; and a dehumidifying apparatus for removing moisture generated from the laundry.

With such configuration, the moisture generated from the laundry still left in the inner tub after the laundry is washed is outwardly exhausted, accordingly it is capable of preventing odor or mold from being generated in the washing machine or the laundry.

Here, the dehumidifying apparatus is implemented as a blow means formed at the door.

Further, the dehumidifying apparatus further comprises exhaust holes for exhausting the moisture therethrough. The exhaust holes may be formed at least one of the door, the top cover and the casing. By the exhaust holes, it is capable of effectively exhausting the moisture of the laundry collected by the blow means out of the washing machine.

Meanwhile, the dehumidifying apparatus comprises the blow means installed at the casing and an exhaust passage communicating the blow means and the inner tub with each other. The exhaust passage may be formed at least one of the casing and the top cover. The blow means is installed at a space between the casing and the outer tub, not the door, thereby utilizing a useless space. And, as the separate exhaust passage is formed, it is capable of effectively connecting the blow means that is not installed at the inner tub to an inside of the inner tub.

Here, the dehumidifying apparatus is operated when a certain time elapses after the washing completion. That is, in case that a user does not take out the laundry in the washing machine even when said certain time elapses after the washing completion, the dehumidifying apparatus is operated thus to enhance sanitary conditions of the laundry.

In accordance with another aspect of the present invention, there is is provided a dehumidifying method of a washing machine, the method comprising: sensing whether or not a door is open when a certain time elapses after a washing completion; determining whether or not the door is open comparing a time spent on sensing whether or not the door is open in the sensing step with a pre-set time; and dehumidifying for removing moisture from laundry by operating a dehumidifying apparatus when it is determined that the door is not open in the determining step.

With such method, it is capable of preventing the laundry from being left after washed and keeping the washed laundry clean.

Here, the sensing step is executed by an opening sensing means installed at least one of the door and the casing coming in contact with the door. And, the steps of sensing, determining and dehumidifying are repeatedly and periodically executed until the opening of the door is sensed. The dehumidifying method of the washing machine is executed with this algorism, accordingly it is capable of consecutively exhausting the moisture even when the washed laundry is left for a long time.

And, an execution time for each step of sensing through dehumidifying may be variable, but a total execution time for the steps of sensing through dehumidifying is limited. If the dehumidifying method is unlimitedly executed repeatedly or periodically, a power consumption may increase and it may badly affect a mechanical durability of the washing machine. Thus, preferably, the total execution time is limited.

The dehumidifying step is executed by a blow means formed at the door.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate preferred embodiments of the invention and together with the description serve to explain the principles of the invention.

In the drawings:

FIG. 1 is an exploded perspective view showing a washing machine in accordance with one embodiment of the present invention;

FIG. 2 is a perspective view showing a door of the washing machine of FIG. 1;

FIG. 3 is a sectional view showing the door taken along line III-III in FIG. 2;

FIG. 4 is a perspective view showing a washing machine in accordance with another embodiment of the present invention; and

FIG. 5 is a flow chart showing a dehumidifying method of a washing machine in accordance with the present invention.

### DETAILED DESCRIPTION OF THE INVENTION

Hereafter, description will now be given in detail of the preferred embodiments of the present invention, examples of which are illustrated in the accompanying drawings.

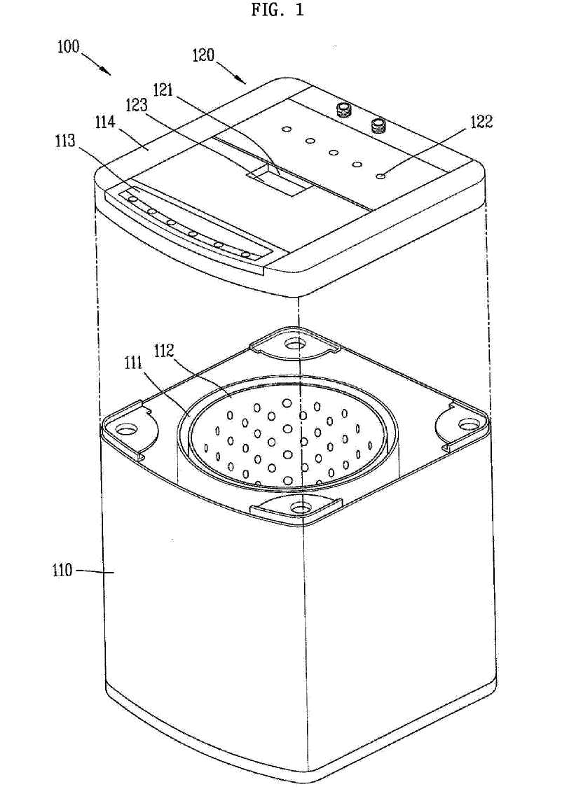

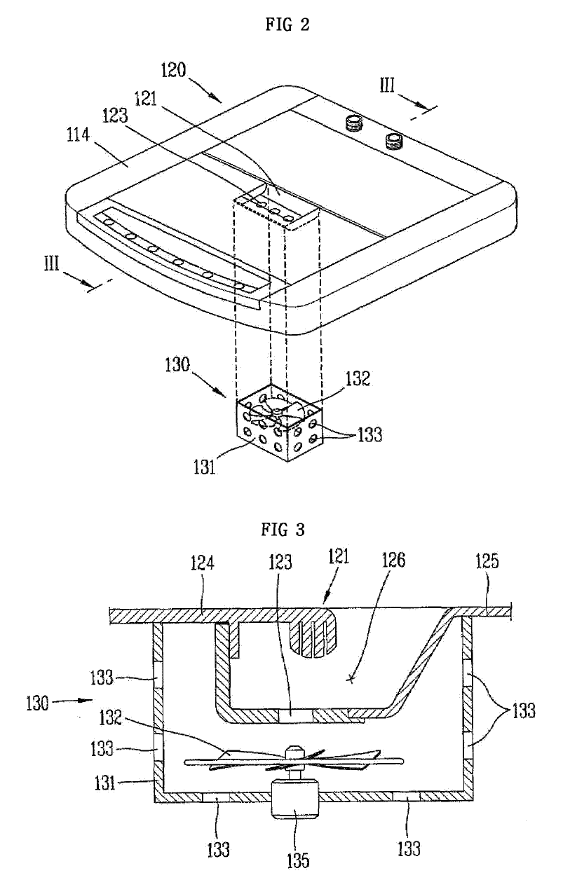

FIG. 1 is an exploded perspective view showing a washing machine in accordance with one embodiment of the present invention, FIG. 2 is a perspective view showing a door of the washing machine of FIG. 1, and FIG. 3 is a sectional view showing the door taken along line III-III in FIG. 2.

As shown in FIG. 1 or 2, a washing machine 100 in accordance with one embodiment of the present invention includes a casing 110 forming an appearance, a door 120 installed at one side of the casing 110 so as to receive laundry therein, a top cover 114 opened/closed by the door 120, an outer tub 111 installed in the casing 110, an inner tub 112 rotatably installed in the outer tub 111 and a dehumidifying apparatus 130 for removing moisture generated from the laundry.

The door 120 is provided with a handgrip 121 by which the door 120 is easily opened/closed, and exhaust holes 123 through which air or moisture in the washing machine 100 is outwardly exhausted. The exhaust holes 123 may not be provided considering the appearance of the washing machine 100.

And, the top cover 114 is provided with a control panel 113 by which operation courses are controlled and any operation course selected by a user is inputted.

Here, it is effective that the dehumidifying apparatus 130 is implemented as a blow means 130 formed at the door 120. The blow means 130 may be formed at a lower portion of the door 120 or an inner surface thereof as shown in FIG. 2. Since the dehumidifying apparatus or blow means 130 serves to effectively exhaust the moisture or the like generated from the laundry in the inner tub 112 when the door 120 is closed, the blow means 130 is preferably installed at a position where the blow means 130 can exhaust much amount of moisture from the inner tub 112. Thus, it is effective that the blow means 130 is installed at the lower portion of the door 120 or the inner surface thereof.

The blow means 130 includes a housing 131 having a specific space and a fan 132 formed in the housing 131. Preferably, the housing 131 is provided with suction holes 133 through which the moisture or odor generated from the inner tub 112 flows toward the fan 132.

The housing 131 is mounted below the handgrip 121 of the door 120. Here, the handgrip 121 is provided with the exhaust holes 123 for outwardly exhausting the moisture or the like blown by the fan 132. The blow means 130 and the exhaust holes 123 formed at the handgrip 121 will be described in detail with reference to FIG. 3.

As shown in FIG. 3, the handgrip 121 is formed by a first door member 124 and a second door member 125 overlapping the first door member 124 with a certain gap therebetween. Here, the second door member 125 partially overlapping the first door member 124 is positioned below the first door member 124. Accordingly, a space 126 in which a user's hand can be putted is obtained.

The exhaust holes 123 are formed at the second door member 125 forming the space 126. That is, the exhaust holes 123 are formed at the second door member 125 partially overlapping the first door 124 with said certain gap therebetween. Accordingly, the exhaust holes 123 are not outwardly exposed by the first door member 124 covering them, thereby less affecting the appearance of the washing machine 100.

Not considering the appearance of the washing machine 100, the exhaust holes 123 may be formed at the casing 110 or the top cover 114.

And, the housing 131 is formed below the door 120 having the space and provided with the fan 132 therein. A driving apparatus 135 for driving the fan 132 is installed at the housing 131. The housing 131 is provided with the suction holes 133 through which the moisture existing in the inner tub 112 or the like can pass. The suction holes 133 may be formed at a lower surface or lateral surfaces of the housing 131.

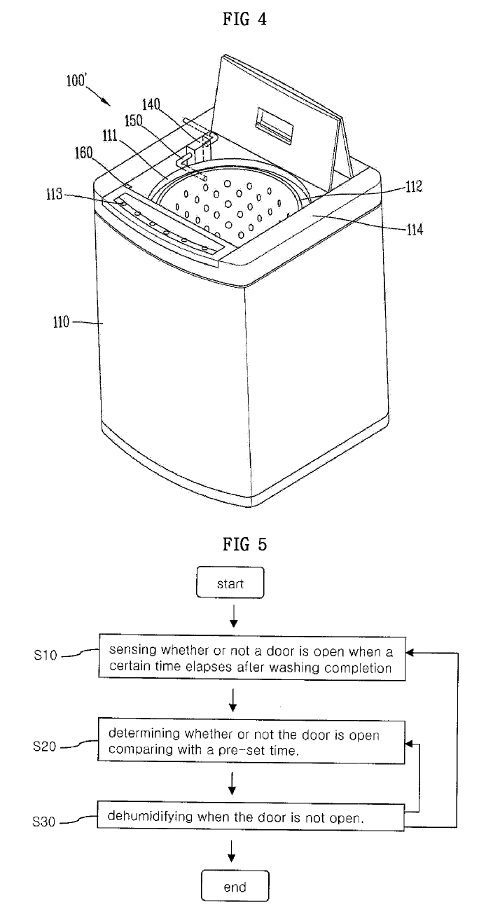

FIG. 4 is a perspective view showing a washing machine in accordance with another embodiment of the present invention. A washing machine 100′ shown in FIG. 4 includes the casing 110 forming an appearance, the door 120 installed at one side of the casing 110 so as to receive laundry therein, the top cover 114 opened/closed by the door 120, the outer tub 111 installed in the casing 1107 the inner tub 112 rotatably installed in the outer tub 111, a blow means 140 installed at the casing 110 so as to remove moisture generated from the laundry, and an exhaust passage 150 for communicating the blow means 140 and the inner tub 112 with each other.

Here, the exhaust passage 150 should be communicated with the inner tub 112. And, effectively, the exhaust passage 150 is penetratingly formed at least one of the casing 110 and the top cover 114.

The aforementioned dehumidifying apparatus or blow means is operated when a certain time elapses after washing completion (i.e., the laundry is washed). That is, if the user does not take out the laundry or the washing machine does not proceed to another operation course when said certain time elapses after the washing completion, the dehumidifying apparatus 130, 140 is operated. If the dehumidifying apparatus is operated right after the washing completion, there may be a drawback that the washing machine wastes much energy.

Here, an opening sensing means 160 formed at least one of the door 120 and the top cover 114 coming in contact with the door 120 senses whether or is not the door 120 is open. The opening sensing means 160 may be formed at the casing 110 coming in contact with the door 120.

Hereafter, a dehumidifying method of the washing machine in accordance with the present invention. FIG. 5 is a flow chart showing the dehumidifying method of the washing machine in accordance with the present invention.

Referring to FIG. 5, the dehumidifying method of the washing machine in accordance with the present invention includes sensing whether or not the door 120 is open when a certain time elapses after washing completion (S1), determining whether or not the door 120 is open comparing a time spent on sensing whether or not the door 120 is open in the sensing step S1 with a pre-set time (S2), and dehumidifying for removing moisture from laundry by operating the dehumidifying apparatus 130, 140 when it is determined that the door 120 is not open in the determining step S2 (S3).

Preferably, the steps of sensing S1, determining S2 and dehumidifying S3 are consecutively executed until the opening of the door 120 is sensed, and the steps are repeatedly and periodically executed so as to effectively exhaust the moisture or odor caused by the moisture.

That is, the first step, the sensing step S1 may be repeatedly executed after the dehumidifying step S3, or the determining step S2 may be repeatedly executed right after the dehumidifying step S3 is executed.

However, if the processes are unlimitedly executed without a time limit, the washing machine may waste energy and have a bad durability. Thus, a total execution time for the steps of sensing S1 through dehumidifying S3 may be limited. Here, each execution time for the steps of sensing S1 through dehumidifying S3 may be variable within the total execution time. The execution time may be set through the control panel 113 when the user sets the operation course.

For example, when the user does not open the door 120 of the washing machine 100 and take out laundry up to 10 minutes later after the washing completion, the opening sensing means 160 senses whether or not the door 120 is open from a point of time that 10 minutes elapses after the washing completion. Alternately, the sensing step whether or not the door is open may be started right after the washing completion.

If the door 120 is not open from the point of time that 10 minutes elapses after the washing completion until 5 minutes (pre-set time) further elapses, it is determined that the door 120 is not open in the determining step S2. Then, in the dehumidifying step S3, the dehumidifying apparatus 130, 140 is operated for 1 minute so as to exhaust the moisture or odor.

After the dehumidifying step S3 is executed for 1 minute, the first step, the sensing step S1 may be repeatedly executed. Alternately, the determining step S2 may be repeatedly executed right after the dehumidifying step S3. Here, the total execution time for the steps of sensing S1 through dehumidifying S3 is not over 2 hours.

The above description is merely exemplary with respect to setting of execution time for each step or all steps of the dehumidifying method, but the user can variously set the time.

Here, the dehumidifying step S3 is executed by the blow means 130, 140 formed at the door 120 or the casing 110.

A means for transferring a signal or information between each step is not disclosed here, however any signal transfer means used in a sensing field can be applied.

The aforementioned dehumidifying apparatus can be applied to the front loading washing machine as well as the top loading washing machine.

As aforementioned, first, the present invention provides the washing machine having the dehumidifying apparatus which is capable of outwardly exhausting the moisture generated from the laundry left in the washing machine after the washing completion.

Second, in accordance with the present invention, the washing machine is provided with the dehumidifying apparatus, thereby being capable of less generating a foreign substance or odor caused by the moisture in the washing machine after the washing completion.

Third, the present invention provides the dehumidifying method of the washing machine which is capable of periodically or repeatedly dehumidifying using the dehumidifying apparatus thus to increase the dehumidifying efficiency.

Fourth, the present invention provides the dehumidifying method of the washing machine which is capable of automatically dehumidifying when the opening of the door of the washing machine is not sensed for a certain time thus to provide the user with convenience.

The foregoing embodiments and advantages are merely exemplary and are not to be construed as limiting the present disclosure. The present teachings can be readily applied to other types of apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present inventive features may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

1. A washing machine comprising:
a casing forming an appearance;
a door installed at one side of the casing so as to receive laundry therein;
a top cover opened/closed by the door;
an outer tub installed in the casing;
an inner tub rotatably installed in the outer tub; and
a dehumidifying apparatus provided with a blow means and exhaust holes formed at the door so as to remove moisture generated from the laundry.

2. The washing machine of claim 1, wherein the blow means comprises a housing provided with suction holes and a fan installed in the housing.

3. The washing machine of claim 1, wherein the exhaust holes are connected to a handgrip of the door.

4. A washing machine comprising:
a casing forming an appearance;
a door installed at one side of the casing so as to receive laundry therein;
a top cover opened/closed by the door;
an outer tub installed in the casing;
an inner tub rotatably installed in the outer tub; and
a dehumidifying apparatus provided with a blow means installed at the casing and an exhaust passage communicating the blow means and the inner tub with each other.

5. The washing machine of claim 4, wherein the exhaust passage is formed at least one of the casing and the top cover.

6. The washing machine of claim 1, wherein the dehumidifying apparatus is operated when a certain time elapses after washing completion.

7. A dehumidifying method of a washing machine, in the washing machine comprising: a casing forming an appearance; a door installed at one side of the casing so as to receive laundry therein; a top cover opened/closed by the door; an outer tub installed in the casing; an inner tub rotatably installed in the outer tub; and a dehumidifying apparatus for removing moisture generated from the laundry, the dehumidifying method comprising:
sensing whether or not the door is open when a certain time elapses after washing completion;
determining whether or not the door is open comparing a time spent on sensing whether or not the door is open in the sensing step with a pre-set time; and
dehumidifying for removing moisture from the laundry by operating the dehumidifying apparatus when it is determined that the door is not open in the determining step.

8. The method of claim 7, wherein the sensing step is executed by an opening sensing means installed at least one of the door and the casing coming in contact with the door.

9. The method of claim 7, wherein the steps of sensing, determining and dehumidifying are consecutively executed until the opening of the door is sensed.

10. The method of claim 7, wherein the steps of sensing, determining and dehumidifying are periodically executed until the opening of the door is sensed.

11. The method of claim 7, wherein each execution time for the steps of sensing through dehumidifying is variable, and a total execution time for the steps of sensing through dehumidifying is limited to a pre-set range of time.

12. The method of claim 7, wherein the dehumidifying step is executed by a blow means installed at the door or the casing.

13. The method of claim 7, wherein the blow means comprises a housing provided with exhaust holes and a fan installed in the housing.

14. The washing machine of claim 4, wherein the dehumidifying apparatus is operated when a certain time elapses after washing completion.
